(19) United States
(12) Patent Application Publication
(10) Pub. No.: US 2026/0294592 A1
(43) Pub. Date: Oct. 1, 2026

(54) INTERMEDIATE ABUTMENT FOR PROSTHESIS INSTALLATION

(71) Applicant: VP INNOVATO HOLDINGS LTD., Aradippou, Larnaca (CY)

(72) Inventors: Ioannis VERGOULLIS, Rhodes (GR); Georgios PAPADOPOULOS, Oroklini (GR)

(21) Appl. No.: 19/479,703

(22) PCT Filed: Apr. 11, 2024
(86) PCT No.: PCT/IB2024/053529

§ 371 Date: Oct. 28, 2025

(30) Foreign Application Priority Data
May 16, 2023 (GR) 20230100398

(51) Int. Cl. A61C 8/00

(52) U.S. Cl. CPC A61C 8/0069; A61C 8/0068; A61C 8/0074

(57) ABSTRACT

An intermediate abutment includes a prosthetic connection, an upper pillar, and a shoulder. The prosthetic connection extends along a prosthetic connection axis. The upper pillar extends along a pillar axis and includes a frustoconical outer surface around the pillar axis. The frustoconical outer surface includes at least two planar surfaces. The shoulder is located between the prosthetic connection and the upper pillar. The upper pillar includes an inner threaded portion configured to receive a screw and at least one scan mark located in one of the planar surfaces.

### TECHNICAL FIELD

This invention belongs to the field of tools used by dentists for operating in dental tissue, in order to manage the soft tissue around implants or similar operations.

### STATE OF THE ART

The placement of a dental implant involves many operations, some of them being related to the manufacturing and handling of healing abutments, impression posts and implant supported prostheses.

One way of performing these dental operations is by means of the so-called “intermediate abutments”. These parts are prosthetic abutments which are installed onto the implant and are furthermore capable to receive a prosthesis or other prosthetic components through an additional couple threading.

These intermediate abutments comprise an upper pillar, which is intended to be coupled to the aforementioned prosthetic component. The engagement between the pillar and the prosthetic component has some requirements which are related to the functionality of the prosthetic component.

In some cases, this coupling has freedom of rotation, since the external surface of the upper pillar and the inner surface of the prosthetic component, which is to be in contact with the upper pillar, are frustoconical, so that this rotation is easily achieved. This type of connection is only valid for multiple-unit fixed prostheses, since the ability to rotate is not suitable for single unit prostheses. In fact, in the case of multiple prostheses, free rotation is desired in non-parallel arrangements, since otherwise, the prostheses would find problems when fitting on the abutments. However, when friction is absent from this conical interaction, all the retention is relied on the screws, and this can also lead to different problems, such as loosening of the screws, micro mobility of the prostheses and so on.

The use of cemented restorations, where the restoration is cemented onto the abutment intra-orally has led to increased number of cases affected by cement sepsis due to cement escape in the surrounding tissues. Thus, a shift has been made to screw retained restorations, meaning dental restorations that can be screwed onto the abutment instead of being cemented intraorally on it. The materials which are used for the manufacturing of these dental prostheses (ceramics, zirconia, etc) are very fragile, so that they can break once screwed onto the abutment and receiving a proper torque.

An improvement in the use and design of these intermediate abutments is therefore sought.

### DESCRIPTION OF THE INVENTION

The invention provides an alternative solution for this problem by means of an intermediate abutment according to claim 1, and a dental system according to claim 14. Preferred embodiments of the invention are defined in dependent claims.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In this text, the term “comprises” and its derivations (such as “comprising”, etc.) should not be understood in an excluding sense, that is, these terms should not be interpreted as excluding the possibility that what is described and defined may include further elements, steps, etc.

In a first inventive aspect, the invention provides an intermediate abutment comprising
a prosthetic connection extending along a prosthetic connection axis,
an upper pillar extending along a pillar axis, the upper pillar comprising a frustoconical outer surface around the pillar axis, the frustoconical outer surface being cut by at least two planar surfaces; and
a shoulder located between the prosthetic connection and the upper pillar;
wherein the upper pillar comprises an inner threaded portion suitable for receiving a screw.

The prosthetic connection is intended to abut against a prosthetic connection of an implant, which is not part of the invention. The shoulder is intended to be in contact with gingival tissue and the upper pillar is intended to receive a supra-structure (such as a prosthesis or such as an intermediate auxiliary post, as will be shown below) which is configured to be attached to the intermediate abutment by means of a screw which is threaded into the inner threaded portion of the upper pillar.

With this intermediate abutment, it is possible to install different elements that can be replaced during the healing process. The same intermediate abutment is used for the intermediate auxiliary posts (also called cylinders, although they do not have a cylindrical shape) and for the prosthesis, and can be installed either on a single unit or on a multiple unit, since the intermediate abutment of the invention accepts an intermediate auxiliary post which may freely rotate and an intermediate auxiliary post which is blocked by the interaction of the planar surfaces. Both intermediate auxiliary posts are also covered by different inventive aspects of the invention.

In some particular embodiments, the upper pillar comprises bevelled edges. These bevelled edges are intended to interact through friction fit with corresponding bevelled edges which are comprised in the inner surface of an intermediate auxiliary post that is aimed to be coupled onto the pillar of the intermediate abutment and abut onto its shoulder (as will be described later in the application). These bevelled edges can form an angle comprised between 1 and 60 degrees angle in relation to the prosthesis axis of the intermediate abutment in different embodiments. The interaction between the bevelled surfaces of the planar surfaces and the corresponding bevelled surfaces of the intermediate auxiliary post increases the friction fit so that in addition to the anti-rotation effect that the planar surfaces provide, the bevelled surfaces will add vertical friction fit to minimize the chance for vertical disengagement of the coupling components.

In some particular embodiments, the planar surfaces are parallel to the pillar axis. In different embodiments, they form between 5° and 20° with respect to the pillar axis.

In some particular embodiments the frustoconical outer surface comprises an upper portion and a bottom portion, wherein the upper portion forms a first angle with respect to the prosthetic connection axis and the bottom portion forms a second angle with respect to the prosthetic connection axis, the second angle being different from the first angle. These embodiments will therefore provide an intermediate abutment with a pillar comprising double conicity. This means that the pillar will comprise two distinct portions (upper portion and bottom portion) which forms different degrees of angulation in relation to each other and to the axis of the prosthesis. These two portions provide for a first and a second conus. This technical feature allows the coupling or engagement of a prosthetic piece (such as an intermediate auxiliary post, a prosthesis, an impression post, etc) that comprises corresponding geometries/surfaces in its internal surface in an advantageous manner: a first engagement takes place when the first conus (corresponding to the upper portion of the planar surface) interacts and a second stronger engagement will be provided when the second conus interact. Such a technical feature allows an adequate coupling of the components with low torque values that will activate only one of the conus. This is useful when the coupling components need to be easily uncoupled after the clinical process (e.g., a scanning process or an impression process) is completed. However, the application of higher torque values will activate the interaction of both conus providing for a stronger friction/coupling similar to a cold-welding effect.

In some particular embodiments, the intermediate abutment comprises an even number of planar surfaces, wherein each planar surface is parallel to another planar surface.

An even number of planar surfaces provides an easy way of manufacturing the corresponding surface of a cylinder which matches the planar surfaces of the upper pillar. In some particular embodiments, the prosthetic connection comprises a deep portion and a shallow portion, the shallow portion being located between the deep portion and the shoulder, wherein the deep portion comprises a frustoconical surface which forms between 0.1° and 2° with respect to the prosthetic connection axis and wherein the shallow portion comprises a frustoconical surface which forms between 30° and 60° with respect to the prosthetic connection axis.

The deep portion is intended to be introduced in a hole of the implant, which is in the centre of an anti-rotation structure which may comprise a polygonal structure. The slight slope of this deep portion is intended to create a first friction fit with the implant, but without preventing the intermediate abutment from rotating with respect to the implant (which is important in the cases where the intermediate abutment comprises an integrated threaded connecting portion to be screwed to the implant). The shallow portion abuts against a shallow portion of the implant, which has a similar geometry.

In some particular embodiments, the intermediate abutment further comprises at least one scan mark.

This scan mark is useful to provide, at a single glance, the specific measurements and features of the specific intermediate abutment.

In some particular embodiments, at least one of the scan marks is located in one of the planar surfaces.

In some particular embodiments, the upper pillar of the intermediate abutment presents a surface roughness that is larger than the surface roughness of the remainder exterior surface of the intermediate abutment. Thus, the portion where the scan mark is located has a surface roughness larger (i.e., it is rougher and does not reflect light as well as the other portion) than the bottom portion, which has a smaller surface roughness, has a better light reflection, can be, e.g. highly polished. This rough portion (which can be obtained, e.g., by hard anodization or blasting) allows the scan mark to be easily scannable while the highly polished surface of the rest of the exterior surface, which is not intended to be scanned, provides favourable interaction with the soft tissue and the shoulder of the intermediate abutment.

A planar surface is an accessible an easy location to detect the scan mark.

In some particular embodiments, the intermediate abutment further comprises a threaded lower pillar connected to the prosthetic connection and suitable for being screwed into an external threaded element.

This threaded portion is optional, since in some cases the intermediate abutment may be connected to the implant by other means. However, it is typical that the way of connecting both elements is by means of this additional threaded lower pillar.

In alternative embodiments, the intermediate abutment has a retention hole configured to receive a retention screw. This retention screw is used to secure the intermediate abutment onto the implant. These embodiments are specifically recommended when the upper pillar axis is not parallel with the axis of the prosthetic connection of the intermediate abutment. In some particular embodiments, the shoulder comprises a shoulder surface which extends along the prosthetic connection axis, wherein the shoulder surface comprises a frustoconical surface or a concave surface or a convex surface or a cylindrical surface or a combination thereof. In some particular embodiments, the prosthetic connection axis is parallel to the pillar axis or coincident with the pillar axis, but in different embodiments, the prosthetic connection axis forms an angle lower than 45° with respect to the pillar axis.

In some particular embodiments, the shoulder comprises a peripheral bevelled portion in the end of the shoulder which is closest to the upper pillar. This bevelled portion aims to interact through friction fit with a corresponding bevelled surface present in the internal surface of an intermediate auxiliary post. This bevel surface forms an angle which is lower or equal to 45 degrees with respect to the prosthetic connection axis. This technical feature enhances the friction fit of the coupling components.

When the two axes coincide, a straight abutment with symmetrical shape is obtained. If the two axes are parallel but do not coincide, then a straight abutment with an asymmetrical shape is obtained. When the two axes form an angle in any of these two scenarios (crossing axes or skew axes), the abutments are at the same time “angulated” abutments (either symmetrical or asymmetrical).

This angulation allows the dental practitioner to achieve a better adaptation between the shoulder and the gingival tissue, which may have a different orientation from the pillar axis.

In some particular embodiments, a portion of the planar surface of the intermediate auxiliary post presents a surface roughness that is larger than the surface roughness of the exterior surface of the rest of the intermediate abutment. Thus, the portion of the planar surface which comprises the scan mark has a surface roughness larger (i.e., it is rougher and does not reflect light as well as the other portion) than the rest of the surface of the intermediate abutment, which has a smaller surface roughness, has a better light reflection, can be, e.g. highly polished. The rough portion (which can be obtained, e.g., by hard anodization or blasting) allows the scan mark to be easily and more accurately scannable while the highly polished surface of the rest of the intermediate abutment, that is not intended to be scanned, provides favourable interaction with the soft tissue and the peri-implant bone.

In a further inventive aspect, the invention provides a first intermediate auxiliary post with a first axis, the first intermediate auxiliary post comprising
a first open end configured to be inserted in the upper pillar of an intermediate abutment according to the first inventive aspect;
a second end opposite to the first end;
an exterior surface between the first end and the second end; and
an interior surface between the first end and the second end, wherein the interior surface comprises a frustoconical portion.

This first intermediate auxiliary post, which is sometimes called cylinder, is suitable for being coupled to the upper pillar of an intermediate abutment as defined in the first inventive aspect. This coupling is made without any rotation prevention, since the frustoconical portion of the interior surface of this first intermediate auxiliary post is configured to match with the frustoconical outer surface of the upper pillar of the intermediate abutment, so that the first intermediate auxiliary post can freely rotate with respect to the intermediate abutment. This is useful in the event of multiple implants which are not parallel.

In some particular embodiments, the second end is open.

This is useful to insert a screw to attach the first intermediate auxiliary post to the upper pillar of the intermediate abutment.

In some particular embodiments, the exterior surface comprises a circular grove extended around a circumference of the exterior surface perpendicular to the first axis.

This groove may be used as a further identification item for identifying the auxiliary post.

In some particular embodiments, the exterior surface comprises at least one planar surface.

This planar surface is used to create an anti-rotation effect for the part which is installed on the intermediate auxiliary post (such as a prosthesis).

In some particular embodiments, the first intermediate auxiliary post further comprises a scan mark in the planar surface.

In a further inventive aspect, the invention provides a second intermediate auxiliary post with a second axis, the second intermediate auxiliary post comprising
a first open end configured to be inserted in the upper pillar of an intermediate abutment according to the first inventive aspect;
a second end opposite to the first end;
an exterior surface between the first end and the second end; and
an interior surface between the first end and the second end, wherein the interior surface comprises a plurality of planar surfaces.

This second intermediate auxiliary post, which is sometimes called cylinder, is suitable for being coupled to the upper pillar of an intermediate abutment as defined in the first inventive aspect. This coupling is made with rotation prevention, so that the second intermediate part cannot rotate with respect to the intermediate abutment. This is useful in the event of single unit implants.

In some particular embodiments, the second end is open.

This is useful to insert a screw to attach the first intermediate auxiliary post to the upper pillar of the intermediate abutment.

In some particular embodiments, the second intermediate auxiliary post comprises an even number of planar surfaces, wherein each planar surface is parallel to another planar surface.

These planar surfaces are suitable for coupling with the planar surfaces of the upper pillar.

In some particular embodiments, a bottom portion of the interior surface of the second intermediate auxiliary post comprises a peripheral bevelled surface. This peripheral bevelled surface aims to interact through friction fit with a corresponding bevelled surface present on the top margin of the shoulder of the intermediate abutment. This bevelled surface forms an angle equal or lower than 45 degrees with respect to the second axis.

In some particular embodiments, the exterior surface comprises a circular grove extended around a circumference of the exterior surface perpendicular to the second axis.

In some particular embodiments, the exterior surface comprises at least one planar surface.

This planar surface is used to create an anti-rotation effect for the part which is installed on the intermediate auxiliary post (such as a prosthesis).

In some particular embodiments, the second intermediate auxiliary post further comprises a scan mark in the planar surface.

In some particular embodiments, the interior surface comprises a portion of a frustoconical surface intersected by the planar surfaces.

In this embodiment, the second intermediate auxiliary post has an internal geometry at its bottom portion that is the exact negative replication of the exterior surface of the pillar of the intermediate abutment of the first inventive aspect (with planar surfaces intersecting a portion of a frustoconical surface). Thus, once the second intermediate auxiliary pillar is installed on the intermediate abutment, these surfaces interact by means of friction fit and achieve a cold-welding effect that increases the vertical retention and at the same time eliminates lateral and rotational movement.

In a further inventive aspect, the invention provides a dental system comprising
an intermediate abutment according to the first inventive aspect;
a first intermediate auxiliary post according to the second inventive aspect; and
a second intermediate auxiliary post according to the third inventive aspect; wherein
the interior surface of the first intermediate auxiliary post fits with the frustoconical outer surface of the upper pillar of the intermediate abutment; and
the interior surface of the second intermediate auxiliary post fits with the planar surfaces of the upper pillar of the intermediate abutment.

This system is advantageous since it provides all the necessary elements (and a minimum amount of them) to carry out the implant operation in a patient. The intermediate auxiliary posts are suitable for multiple-unit or single-unit prostheses, while they eliminate the need of further reusable scan posts.

In some particular embodiments, a portion of the exterior surface of the first and/or the second auxiliary intermediate post pillar presents a surface roughness that is larger than the surface roughness of the remainder exterior surface of the intermediate abutment. Thus, the portion where the scan mark is located has a surface roughness larger (i.e., it is rougher and does not reflect light as well as the other portion) than the bottom portion, which has a smaller surface roughness, has a better light reflection, can be, e.g. highly polished. This rough portion (which can be obtained, e.g., by hard anodization or blasting) allows the scan mark to be easily scannable while the highly polished surface of the rest of the exterior surface, which is not intended to be scanned, provides favourable interaction with the soft tissue and the shoulder of the intermediate abutment.

In some particular embodiments, the dental system further comprises a plate, wherein the plate comprises a plate hole which is configured to fit the exterior surface of the first intermediate auxiliary post or the exterior surface of the second intermediate auxiliary post.

These plates provide for a solid surface that can accelerate the scanning process and improve the accuracy of scanning by providing a solution to the inaccuracy in the scanning process caused by the soft tissue present on the edentulous sites between the intermediate auxiliary scan posts.

In some particular embodiments, the plate comprises a first portion and a second portion, the second portion having a lower thickness than the first portion, wherein the second portion comprises the plate hole.

This thinner first region makes the scan marks on the top surface of the intermediate abutment visible. The thicker portion advantageously adds rigidity to the plate, which is convenient in the event the plate is made in a fragile material.

In some particular embodiments the first portion comprises an asymmetrical shape with combination of at least one bevelled and at least one flat surface.

In some particular embodiments, the plate comprises at least one scan mark.

In some embodiments the plate hole has a geometry (e.g., having at least one planar surface) that allows the scan plates to be installed onto the auxiliary post in a stable position with no rotational movement possible.

In some embodiments the scan mark/s present on the intermediate abutment and/or the auxiliary posts and/or the scan plates comprise a consistent three-dimensional location relationship to each other and this way they provide information for the location of each other.

In some particular embodiments the scan mark of the plate comprises a constant three-dimensional relationship with the scan mark of the intermediate auxiliary post and, or the scan mark of the intermediate abutment. Thus, the scan mark of the plate can provide information with regards to the three-dimensional location of the other scan marks in space.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows a perspective view of an intermediate abutment according to the invention.

FIG. 2 shows a connection between an intermediate abutment according to the invention and an implant.

FIG. 3 shows an alternative embodiment of an intermediate abutment according to the invention.

FIG. 4 shows a perspective view of a first intermediate auxiliary post according to the invention.

FIG. 5 shows a bottom view of this first intermediate auxiliary post of FIG. 4.

FIG. 6 shows a perspective view of a second intermediate auxiliary post according to the invention.

FIG. 7 shows a bottom view of this second intermediate auxiliary post of FIG. 6.

FIG. 8 shows the interaction between an alternative embodiment of an intermediate abutment according to the invention and an alternative embodiment of an intermediate auxiliary post according to the invention.

FIG. 9 shows the use of some plates in an intermediate step of a method of use of a system according to the invention.

### DETAILED DESCRIPTION OF THE INVENTION

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

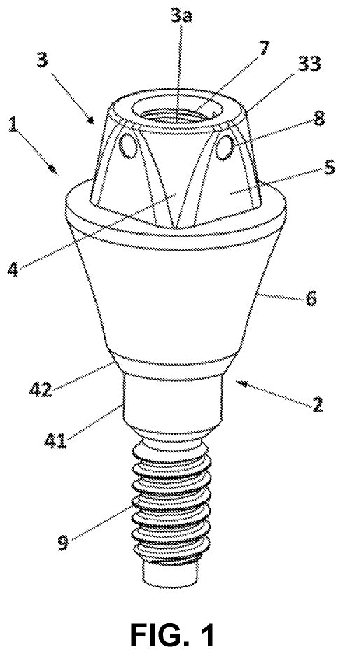

FIG. 1 shows a perspective view of an intermediate abutment 1 according to the invention. This intermediate abutment 1 comprises
a threaded lower pillar 9;
a prosthetic connection 2 comprising a deep portion 41 and a shallow portion 42;
an upper pillar 3 extended along a pillar axis 3a; and
a shoulder 6 located between the prosthetic connection 2 and the upper pillar 3,

The threaded lower pillar 9 is suitable for being screwed into a threaded element. This happens when the intermediate abutment 1 is screwed on a previous implant which is installed in the patient's mouth. The intermediate abutment 1 is used as an intermediate part between the implant and the prosthesis.

This upper pillar 3 also comprises a bevelled edge 33, which forms 45 degrees with respect to the pillar axis 3a. This bevelled edge will interact with further elements to be installed in the intermediate abutment 1.

In some embodiments, the intermediate abutment does not comprise the portion of threaded lower pillar. In these embodiments the intermediate abutment is secured onto the implant with the use of an auxiliary retention screw. These embodiments are useful when combined with the embodiments where the upper pillar axis is not parallel with the axis of the prosthetic connection of the intermediate abutment. In these embodiments, that do not need to rotate to be installed into the implant, the prosthetic connection may comprise two portions: a shallow portion intended to contact a frustoconical portion of the implant, and a deeper portion intended to match in an anti-rotation deeper pattern of the implant (which may be square, hexagonal, octagonal, etc). The deeper portion of the prosthetic connection of the intermediate abutment follows this shape, to prevent rotation. This rotation is not needed, since the connection is performed by an external screw.

However, in the cases like the one of FIG. 1, where the intermediate abutment comprises the threaded lower pillar, the intermediate abutment needs to rotate with respect to the implant to be duly installed into it. Hence, this “deeper portion” cannot be present, since it would prevent the intermediate abutment from rotating and would make installation impossible.

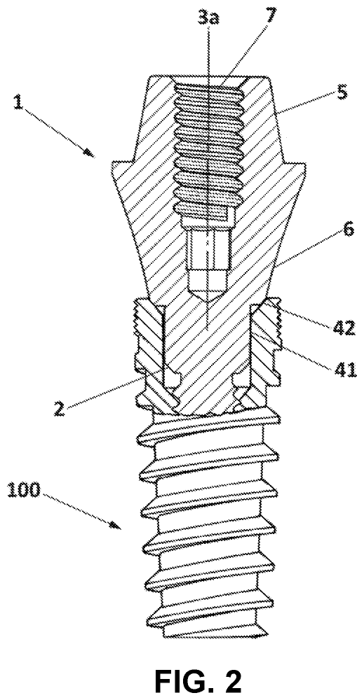

FIG. 2 shows a view of an intermediate abutment 1 according to the invention coupled to an implant 100. As can be seen in this figure, prosthetic connection 2 of the intermediate abutment 1 comprises two portions: a deep portion 41 and a shallow portion 42, which is located between the deep portion 41 and the shoulder 6.

The threaded lower pillar 9 is threaded into the implant to secure the intermediate abutment 1 to the implant 100.

The deep portion 41 is a frustoconical portion, with a surface that forms only 1° with respect to the axis (hence, it is almost a cylindrical portion). This deep portion 41 is intended to provide anti-friction fit and stop the intermediate abutment from lateral movements with respect to the implant. In fact, the 1° slope will make this deep portion to directly interact with the walls of the deep portion of the prosthetic connection of the implant.

The shallow portion 42 has the usual 45° frustoconical portion and is intended to abut in a shallow portion of the prosthetic connection of the implant 100 which has a similar geometry. Coming back to FIG. 1, the upper pillar 3 comprises a frustoconical outer surface 4 around the pillar axis. This frustoconical outer surface is not complete, because it is intersected by four planar surfaces 5. The planar surfaces are parallel to the pillar axis 3a.

In this figure, four planar surfaces and four portions of the frustoconical surface are shown. However, in different embodiments, the number of planar surfaces intersecting the frustoconical surface may be different: in some cases, there may be only three flat surfaces (thus leaving three portions of the frustoconical surface). In other embodiments there may be 6 or 8 flat surfaces, thus leaving the corresponding number of frustoconical portions between the flat surfaces.

The upper pillar also comprises an inner threaded portion 7 suitable for receiving a screw. This screw will be used to attach a prosthesis part to the intermediate abutment.

The shoulder 6 is the portion of the intermediate abutment 1 which is intended to be in contact with gingival tissue. The shoulder 6 comprises a shoulder surface which extends along the prosthetic connection axis, which is in this case is the same as the pillar axis 3a. This shoulder surface may comprise different shapes: frustoconical, cylindrical, concave or convex, or even a combination of two or more of them.

In some cases, this prosthetic connection axis is parallel to the pillar axis 3a, this meaning that the shoulder is “straight”, and is aligned with the orientation of the pillar 3. In fact, in some cases, both axes coincide, such as the case shown in FIG. 1. However, in other cases, the prosthetic connection axis is not parallel to the pillar axis 3a. The prosthetic connection axis is the axis of the introduction of the intermediate abutment in the implant, so it must coincide with the implant axis (the implant is not part of the invention, but is the location where the intermediate abutment is going to be attached). However, the upper pillar axis 3a may, in some cases, be non-parallel to the prosthetic connection axis. Even in other cases, the upper pillar axis 3a can be parallel to the prosthetic connection axis but with a lateral offset (i.e., both axes do not coincide).

The intermediate abutment 1 also comprises a scan mark 8 in one of the planar surfaces 5. This scan mark 8 is used to scan the position and orientation of the intermediate abutment 1, as well as the specific features of the same (e.g., size and type). The intermediate abutment 1 is thus used as a scan post, making it unnecessary for the dental practitioner to use scan posts in addition to the existing abutments.

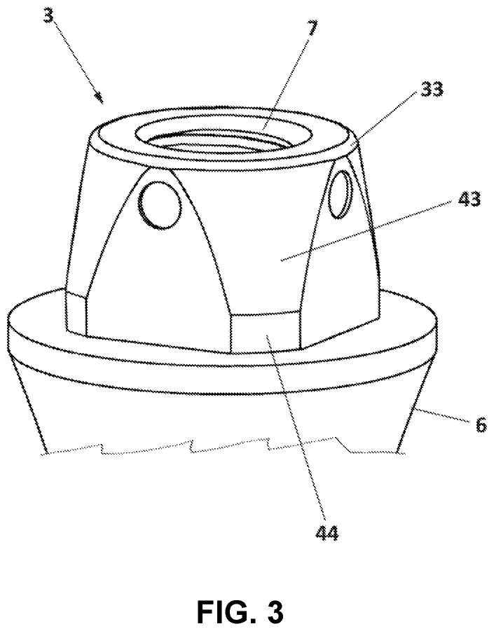

FIG. 3 shows an alternative embodiment of an intermediate abutment 1 according to the invention.

This intermediate abutment is similar to the ones shown in FIGS. 1 and 2. The main difference in this case is that the frustoconical surface 4 of the abutment of FIG. 3 comprises an upper portion 43 and a lower portion 44, wherein the upper portion 43 forms a first angle with respect to the prosthetic connection axis (which in this case is 10°) and the bottom portion forms a different angle with respect to the prosthetic connection axis (which in this case is 1.5°). These two portions provide for a first and a second conus. This technical feature allows the coupling or engagement of a prosthetic piece (such as an intermediate auxiliary post, a prosthesis, an impression post, etc) that comprises corresponding geometries/surfaces in its internal surface in an advantageous manner: a first engagement takes place when the first conus (corresponding to the upper portion of the planar surface) interacts and a second stronger engagement will be provided when the second conus interact. Such a technical feature allows an adequate coupling of the components with low torque values that will activate only one of the conus. This is useful when the coupling components need to be easily uncoupled after the clinical process (e.g., a scanning process or an impression process) is completed. However, the application of higher torque values will activate the interaction of both conus providing for a stronger friction/coupling similar to a cold-welding effect.

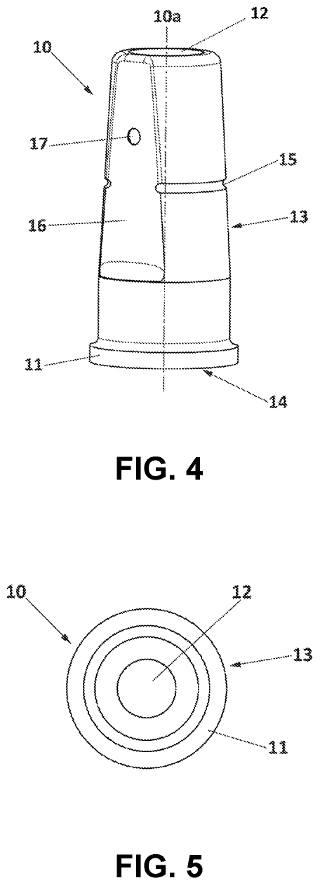

FIG. 4 shows a perspective view of a first intermediate auxiliary post 10 according to the invention. FIG. 5 shows a bottom view of this first intermediate auxiliary post 10.

This first intermediate auxiliary post 10 extends along a first axis 10a, which is contained in a symmetry plane. The first intermediate auxiliary post 10 comprises
a first open end 11 and a second end 12 opposite to the first end 11;
an exterior surface 13 between the first end 11 and the second end 12; and
an interior surface 14 between the first end 11 and the second end 12,

The second end 12 of the first intermediate auxiliary post 10 makes it capable of being inserted in the upper pillar described in FIG. 1. The interior surface 14 comprises a frustoconical portion which fits with the portions of the frustoconical outer surface of the upper pillar of the intermediate abutment of FIG. 1.

Hence, this first intermediate auxiliary post 10 is free to rotate with respect with the intermediate abutment 1 when installed into it. This first intermediate auxiliary post 10 allows the same abutment to support now multiple unit prostheses, thus eliminating the need for an intermediate abutment with different engaging geometry.

The second end 12 of the first intermediate auxiliary post 10 is open, so that a screw can be inserted and a screwdriver can be operated to use the screw to couple the first intermediate auxiliary post 10 to the intermediate abutment.

The exterior surface comprises a circular grove 15 extended around a circumference of the exterior surface perpendicular to the first axis 10a. This groove 15 is used to measure the height of the auxiliary post 10, so that the dental practitioner is able to recognize the height quickly.

The exterior surface 13 comprises a planar surface 16 so that the auxiliary post can admit a further element that cannot rotate with respect to the first intermediate auxiliary post.

This first intermediate auxiliary post further comprises a scan mark 17 in the planar surface 16 because this first intermediate auxiliary post 10 can also work as a scan post to fulfil the requirements of digital impression through intra-oral scanning. They can also function as analogic impression posts to fulfil the purpose of analogic impression. This function can be provided by the planar surfaces 16 present on their exterior surface. These planar surfaces 16 are imprinted into the impression material allowing the cylinder to be installed into the impression material in the correct position with no rotation or lateral movement allowed. Once they conclude their function as scan or impression posts then they are permanently incorporated into the prosthesis and delivered in the patient's mouth onto the intermediate abutment.

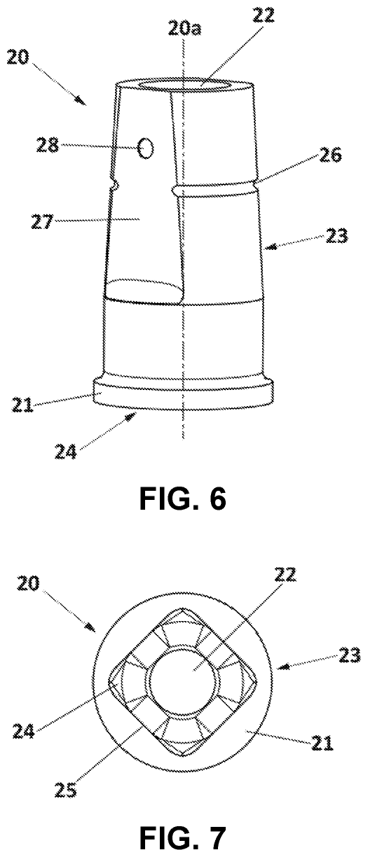

FIG. 6 shows a perspective view of a second intermediate auxiliary post 20 according to the invention. FIG. 7 shows a bottom view of this second intermediate auxiliary post 20.

This second intermediate auxiliary post 20 extends along a second axis 20a, which is contained in a symmetry plane. The second intermediate auxiliary post 20 comprises
a first open end 21 and a second end 22 opposite to the first end 21;
an exterior surface 23 between the first end 21 and the second end 22; and
an interior surface 24 between the first end 21 and the second end 22,

The second end 22 of the second intermediate auxiliary post 20 makes it capable of being inserted in the upper pillar described in FIG. 1. The interior surface 24 comprises four planar surfaces 25 which fits with the planar surfaces of the upper pillar of the intermediate abutment of FIG. 1.

Hence, this second intermediate auxiliary post 20 cannot rotate with respect with the intermediate abutment 1 when installed into it. Further, the portion of frustoconical surface located in the exterior surface of the second intermediate auxiliary post 20 provides an interaction with the portions of frustoconical surface of the intermediate abutment, thus causing a superior stability in lateral and vertical direction through friction fit effect. In this embodiment, the second intermediate auxiliary post has an internal geometry at its bottom portion that is the exact negative replication of the exterior surface of the pillar of the intermediate abutment of FIG. 1. Thus, once the second intermediate auxiliary pillar is installed on the intermediate abutment, these surfaces interact by means of friction fit and achieve a cold-welding effect that increases the vertical retention and at the same time eliminates lateral and rotational movement.

This second intermediate auxiliary post 20 allows the same abutment to support now single unit prostheses, thus eliminating the need for an intermediate abutment with different engaging geometry.

The second end 22 of the first intermediate auxiliary post 10 is open, so that a screw can be inserted and a screwdriver can be operated to use the screw to couple the second intermediate auxiliary post 20 to the intermediate abutment.

The exterior surface comprises a circular grove 26 extended around a circumference of the exterior surface perpendicular to the second axis 20a. This groove 26 is used to measure the height of the auxiliary post 20, so that the dental practitioner is able to recognize the height quickly.

The exterior surface 23 comprises a planar surface 27 so that the auxiliary post can admit a further element that cannot rotate with respect to the second intermediate auxiliary post.

This second intermediate auxiliary post further comprises a scan mark 28 in the planar surface 27 because this second intermediate auxiliary post 20 can also work as a scan post to fulfil the requirements of digital impression through intra-oral scanning. They can also function as analogic impression posts to fulfil the purpose of analogic impression due to the presence of the planar surfaces on their exterior surface. Once they conclude their function as scan or impression posts then they are incorporated into the prosthesis and delivered in the patient's mouth onto the intermediate abutment.

It is also possible to combine some first intermediate auxiliary posts with some second intermediate auxiliary posts in the same treatment process. For example, in the case of multiple units, some prostheses can be installed on first intermediate auxiliary posts and other prostheses can be installed on second intermediate auxiliary posts, depending on the required free-rotation or anti-rotation features. This option can increase the retention capability of the prostheses and reduce the stress applied on the retention screws. This is possible due to the fact that the same intermediate abutment can function with both type of intermediate auxiliary posts.

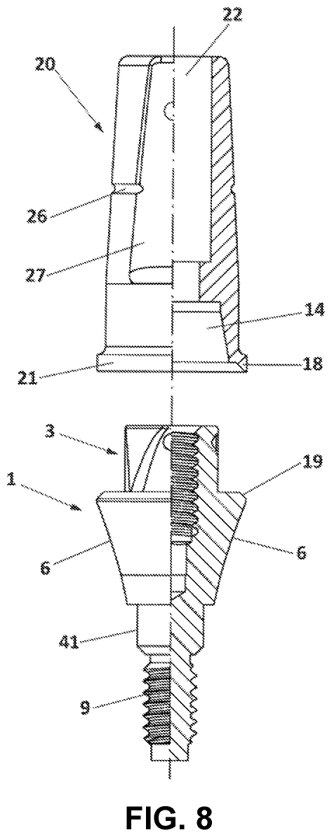

FIG. 8 shows the interaction between an alternative embodiment of an intermediate abutment 1 according to the invention and an alternative embodiment of an intermediate auxiliary post according to the invention. In this case, the intermediate auxiliary post may be a first intermediate auxiliary post or a second intermediate auxiliary post.

In this case, a bottom portion of the interior surface 14 of the corresponding intermediate auxiliary post (which may be a first intermediate auxiliary post or a second intermediate auxiliary post) comprises a peripheral bevelled surface 18. This peripheral bevelled surface 18 aims to interact through friction fit with a corresponding bevelled surface 19 present on the top margin of the shoulder 6 of the intermediate abutment 1. This bevelled surface forms an angle equal or lower than 45° with respect to the second axis.

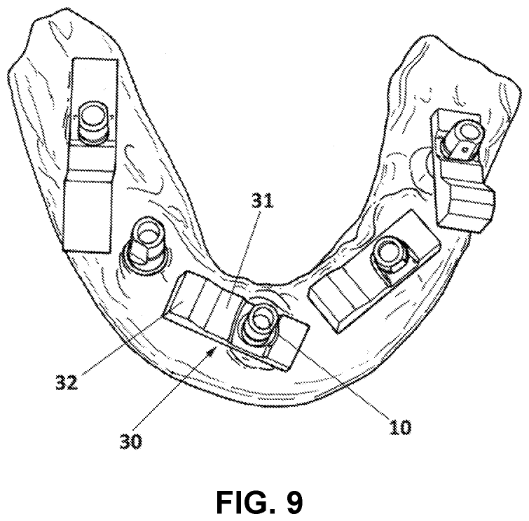

FIG. 9 shows the use of some plates 30 in an intermediate step of a method of use of a system according to the invention. These plates 30 are configured to reversibly engage on the intermediate auxiliary posts by a plate hole which is introduced in the exterior surfaces of the intermediate auxiliary posts. In this figure, different plates 30 are engaged on the exterior surfaces 13 of some first intermediate auxiliary posts 10. The aim of these plates 30 is to improve the scanning process in long span edentulous cases.

These plates 30 provide for a solid surface that can accelerate the scanning process and improve the accuracy of scanning by providing a solution to the inaccuracy in the scanning process caused by the soft tissue present on the edentulous sites between the intermediate auxiliary scan posts.

These plates comprise at least one scan mark that can be used for easy identification of the scan plate shape and dimensions in a CAD software. Also, in some cases, the plate comprising at least one scan mark can be installed onto the auxiliary post in at least one position with no freedom of rotation so that the scan mark of the plate has a stable relationship with the scan mark present on the auxiliary post. In these cases, the CAD software has at least two scan marks available (one of the auxiliary post and one of the scan plate) that are related by a known orientation relation that can be used by the software to improve the accuracy of scanning process.

These plates comprise a cut-out region 31 in the portion of the plate hole. This cut-off region makes the scan marks on the top surface visible. The other portion 32 of the plate is thicker, although this is not essential, but adds rigidity to the plate, which is convenient in the event the plate is made in a fragile material.

In some embodiments the plate hole has a geometry (e.g., having at least one planar surface) that allows the scan plates to be installed onto the auxiliary post in a stable position with no rotational movement possible.

In some embodiments the scan mark/s present on the intermediate abutment and/or the auxiliary posts and/or the scan plates comprise a consistent three-dimensional location relationship to each other and this way they provide information for the location of each other.

The different geometric of surfaces aim to enhance the process of easy identification/match in CAD software, wherein the presence of asymmetrical geometries and bevelled surfaces makes the process more accurate.

In some embodiments, some data about the intermediate abutment and the intermediate auxiliary posts are stored in a digital library of a suitable cad-cam software so that they can be used in digital protocols of impression and prosthesis fabrication.

A possible use of this system would comprise the following steps:
installing an intermediate abutment according to the invention in an implant which is already located in the patient's jaw;
scanning the intermediate abutment, or installing the intermediate auxiliary post onto the implant, or installing the scan plates on the intermediate auxiliary post
scanning or taking an analogic impression of the intermediate auxiliary post;
manufacturing a prosthesis with the information received from the previous scanning step (either from the intermediate abutment or from the intermediate auxiliary post);
cementing the intermediate auxiliary post into the manufactured prosthesis, thus obtaining an installation prosthesis; and
installing the installation prosthesis onto the intermediate abutment.

1.-28. (canceled)

29. An intermediate abutment comprising:
a prosthetic connection which extends along a prosthetic connection axis,
an upper pillar extending along a pillar axis, the upper pillar comprising a frustoconical outer surface around the pillar axis, the frustoconical outer surface comprising at least two planar surfaces;
a shoulder located between the prosthetic connection and the upper pillar;
wherein the upper pillar comprises an inner threaded portion configured to receive a screw; and
at least one scan mark located in one of the planar surfaces.

30. The intermediate abutment according to claim 29, wherein the frustoconical outer surface comprises an even number of planar surfaces, wherein each planar surface is parallel to another planar surface.

31. The intermediate abutment according to claim 29,
wherein the prosthetic connection comprises a deep portion and a shallow portion, the shallow portion located between the deep portion and the shoulder,
wherein the deep portion comprises a deep portion frustoconical surface which forms a first angle between 0.1° and 2° with respect to the prosthetic connection axis, and
wherein the shallow portion comprises a shallow portion frustoconical surface which forms a second angle between 30° and 60° with respect to the prosthetic connection axis.

32. The intermediate abutment according to claim 29, the upper pillar comprises a bevelled edge.

33. The intermediate abutment according to claim 29, further comprising a threaded lower pillar connected to the prosthetic connection and configured to be screwed into an external threaded element.

34. The intermediate abutment according to claim 29, wherein the intermediate abutment further comprises a retention hole configured to receive a retention screw.

35. The intermediate abutment according to claim 29, wherein the shoulder comprises a shoulder surface which extends along the prosthetic connection axis, wherein the shoulder surface comprises at least one of: a frustoconical surface, a concave surface, a convex surface, and a cylindrical surface.

36. The intermediate abutment according to claim 35, wherein the prosthetic connection axis is parallel to the pillar axis or coincident with the pillar axis.

37. The intermediate abutment according to claim 35, wherein the prosthetic connection axis forms an angle smaller than 45° with respect to the pillar axis.

38. The intermediate abutment according to claim 29, wherein the frustoconical outer surface comprises an upper portion and a lower portion, wherein the upper portion forms a first angle with respect to the prosthetic connection axis and the bottom portion forms a second angle with respect to the prosthetic connection axis, the second angle being different from the first angle.

39. The intermediate abutment according to claim 29, wherein the shoulder comprises a peripheral bevelled portion in an end of the shoulder which is closest to the upper pillar.

40. The intermediate abutment according to claim 29, wherein the upper pillar presents a surface roughness that is larger than a surface roughness of a remainder exterior surface of the intermediate abutment.

41. A dental system comprising:
an intermediate abutment according to claim 29;
a first intermediate auxiliary post; and
a second intermediate auxiliary post;
wherein the first intermediate auxiliary post has a first axis and comprises:
a first open end configured to be inserted on the upper pillar of the intermediate abutment;
a second end opposite to the first end of the first intermediate auxiliary post;
an exterior surface between the first end of the first intermediate auxiliary post and the second end of the first intermediate auxiliary post; and
an interior surface between the first end of the first intermediate auxiliary post and the second end of the first intermediate auxiliary post, the interior surface comprising a frustoconical portion;
wherein the second intermediate auxiliary post has a second axis and comprises:
a first open end configured to be inserted on the upper pillar of the intermediate abutment;
a second end opposite to the first end of the second intermediate auxiliary post;
an exterior surface between the first end of the second intermediate auxiliary post and the second end of the second intermediate auxiliary post; and
an interior surface between the first end of the second intermediate auxiliary post and the second end of the second intermediate auxiliary post, the interior surface comprising a plurality of planar surfaces;
and wherein
the interior surface of the first intermediate auxiliary post is friction fit with the frustoconical outer surface of the upper pillar of the intermediate abutment; and
the interior surface of the second intermediate auxiliary post is friction fit with the planar surfaces of the upper pillar of the intermediate abutment.

42. The dental system according to claim 41, wherein the second end of the first intermediate auxiliary post is open.

43. The dental system according to claim 41, wherein the exterior surface of the first intermediate auxiliary post comprises a circular grove extended around a circumference of the exterior surface perpendicular to the first axis.

44. The dental system according to claim 41, wherein the exterior surface of the first intermediate auxiliary post comprises at least one planar surface.

45. The dental system according to claim 44, wherein the first intermediate auxiliary post further comprises a scan mark in the at least one planar surface of the exterior surface of the first intermediate auxiliary post.

46. The dental system according to claim 44, wherein a portion the planar surface of the exterior surface of the first intermediate auxiliary post presents a surface roughness that is larger than a surface roughness of a remainder exterior surface of the first intermediate auxiliary post.

47. The dental system according to claim 41, wherein the second end of the second intermediate auxiliary post is open.

48. The dental system according to claim 41, wherein the interior surface of the second intermediate auxiliary post further comprises an even number of planar surfaces of the plurality of planar surfaces, wherein each planar surface of the plurality of planar surfaces is parallel to another planar surface of the plurality of planar surfaces.

49. The dental system according to claim 41, wherein the exterior surface of the second intermediate auxiliary post comprises a circular grove extended around a circumference of the exterior surface of the second intermediate auxiliary post perpendicular to the second axis.

50. The dental system according to claim 41, wherein the exterior surface of the second intermediate auxiliary post comprises at least one planar surface.

51. The dental system according to claim 50, wherein the second intermediate auxiliary post further comprises a scan mark in the at least one planar surface.

52. The dental system according to claim 41, wherein the interior surface of the second intermediate auxiliary post comprises a portion of a frustoconical surface intersected by at least one planar surface of the plurality of planar surfaces.

53. The dental system according to claim 41, wherein a bottom portion of the interior surface of the second intermediate auxiliary post comprises a peripheral bevelled surface.

54. The dental system according to claim 41, further comprising a plate, wherein the plate comprises a plate hole which is configured to fit the exterior surface of the first intermediate auxiliary post or the exterior surface of the second intermediate auxiliary post.

55. The dental system according to claim 54, wherein the plate comprises a first portion and a second portion, the second portion having a lower thickness than the first portion, wherein the second portion comprises the plate hole.

56. The dental system according to claim 54, wherein the plate comprises at least one scan mark.
